(19) United States
(12) Patent Application Publication
(10) Pub. No.: US 2012/0072443 A1
(43) Pub. Date: Mar. 22, 2012

(54) Data searching system and method for generating derivative keywords according to input keywords

(75) Inventors: Chaucer Chiu, Taipei (TW); Huchen Xu, Shanghai (CN)

(73) Assignee: INVENTEC CORPORATION, Taipei (TW)

(21) Appl. No.: 12/928,594

(22) Filed: Dec. 14, 2010

(30) Foreign Application Priority Data
Sep. 21, 2010 (TW) 099131998

(51) Int. Cl. G06F 17/30

(52) U.S. Cl. 707/769; 707/E17.014

(57) ABSTRACT

A data searching system and method for generating derivative keywords according to input keywords are provided. The data searching system and method extract at least one original input keyword from an input inquiry string by making a comparison with words in a word bank, generate derivative keywords according to the original input keywords, and use the original input keywords and the derivative keywords together to search data. By completing the above procedure, the data searching system and method can therefore achieve the effect of enhancing the data integrity of data searches.

### BACKGROUND OF THE INVENTION

1. Field of Invention

The invention relates to a data system and method and, in particular, to a data searching system and method that generate derivative keywords according to original input keywords.

2. Related Art

Data search is a technique that, after receiving a set of keywords, goes to a database to search for data that include the keywords in a database. This technique has been widely used in web page search engines, electronic or online dictionaries, and various large databases. In the prior art, the search goes by first receiving keywords entered by a user. The keywords are then compared with data. The data containing the keywords are extracted. Therefore, the user can quickly find the information of interest to him from a huge amount of data.

Although data containing the keywords can be found in the conventional data searches, it is impossible to find other possibly related data using derivative keywords. For example, suppose a user wants to search data related to ‘flower’ and ‘vase’. By entering the keywords, ‘flower’ and ‘vase’, the user can obtain data containing one or both of the keywords. However, if the user hopes to use ‘flower’ and ‘vase’ to find data related to the derivative keyword ‘garden’, he has to enter ‘garden’ explicitly. It is still not possible to search for data related to ‘garden’ automatically from the keywords ‘flower’ and ‘vase’.

Although it is possible to suggest the user some commonly used searching words when he enters his keywords, these suggested words have to be those often searched by other people. When the keywords have some correlations but are not frequently searched for, it is not possible to find such keywords. Therefore, there is a problem in making a comprehensive extraction of data related to the input keywords. In the above-mentioned example, although data thus obtained contain the keywords like ‘flower’ and/or ‘vase’, nothing contains only the keyword ‘garden’ can be obtained.

In summary, the prior art has the problem of incomplete data searches. It is therefore imperative to provide a better solution.

### SUMMARY OF THE INVENTION

In view of the foregoing, the invention discloses a data searching system and method that generate derivative keywords according to input keywords.

The disclosed system includes: a database pre-stored with at least one data item; a word bank pre-stored with at least one keyword, wherein, each of the keywords corresponds to at least one index; a receiving module for receiving an inquiry string entered by a user; and a comparison extracting module for comparing the inquiry string with the word bank to obtain at least one first keyword and for extracting at least one index corresponding to each of the first keywords from the word bank for comparison. When the first keywords have at least one common index, at least one second keyword with the common index is extracted from the word bank. All of the first keywords and the second keywords are then used to search for data items in the database. When the first keywords do not have a common index, a word correlation algorithm is employed to obtain at least a third keyword. All of the first keywords and the third keywords are used to search for data items in the database. The system also includes a displaying module foe displaying the extracted data items.

In the above system, the index refers to a classification according to the syntactical function and meaning of the keywords. The word correlation algorithm is a longest common continuous string algorithm or a word combination algorithm. For the longest common continuous string algorithm, the comparison extracting module further combines the longest common continuous string, obtained using the algorithm, and at least one wildcard character to extract at least one third keyword from the word bank. For the word combination algorithm, the comparison extracting module uses at least one combination word, obtained using the algorithm, as the third keyword(s).

The disclosed method includes the steps of: pre-establishing a database stored with at least one data item; pre-establishing a word bank stored with a plurality of keywords, wherein each of the keywords corresponds to at least one index; receiving an inquiry string entered by a user and comparing the string with the word bank to obtain at least one first keyword; extracting at least one index associated with each of the first keywords from the word bank for comparison, wherein when the first keywords have at least one common index, at least one second keyword with the common index is extracted from the word bank and all of the first keywords and the second keywords are then used to search for data items in the database, when the first keywords do not have a common index, a word correlation algorithm is employed to obtain at least one third keyword and all of the first keywords and the third keywords are used to search for data items in the database; and displaying the extracted data items.

In the above method, the index refers to a classification according to the syntactical function and meaning of the keywords. The word correlation algorithm is a longest common continuous string algorithm or a word combination algorithm. For the longest common continuous string algorithm, the method further combines the longest common continuous string, obtained using the algorithm, and at least one wildcard character to extract at least one third keyword from the word bank. For the word combination algorithm, the method uses at least one combination word, obtained using the algorithm, as the third keyword(s).

The disclosed system and method as described above differ from the prior art in that the invention compares the input inquiry string with the word bank to obtain at least one original input keyword. The invention further uses at least one original input keyword to generate derivative keywords. The input keywords and the derivative keywords are all used for data searches.

Through the above-mentioned technique, the invention achieves the effect of enhancing the data integrity in data searches.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed data searching system that generates derivative keywords according to input keywords;

FIG. 2 is a flowchart of the disclosed data searching method that generates derivative keywords according to input keywords;

FIG. 3 is a schematic view of the data search when there are common indices for input keywords in an embodiment; and

FIG. 4 is a schematic view of the data search when there is no common index for input keywords in an embodiment.

### DETAILED DESCRIPTION OF THE INVENTION

The present invention will be apparent from the following detailed description, which proceeds with reference to the accompanying drawings, wherein the same references relate to the same elements.

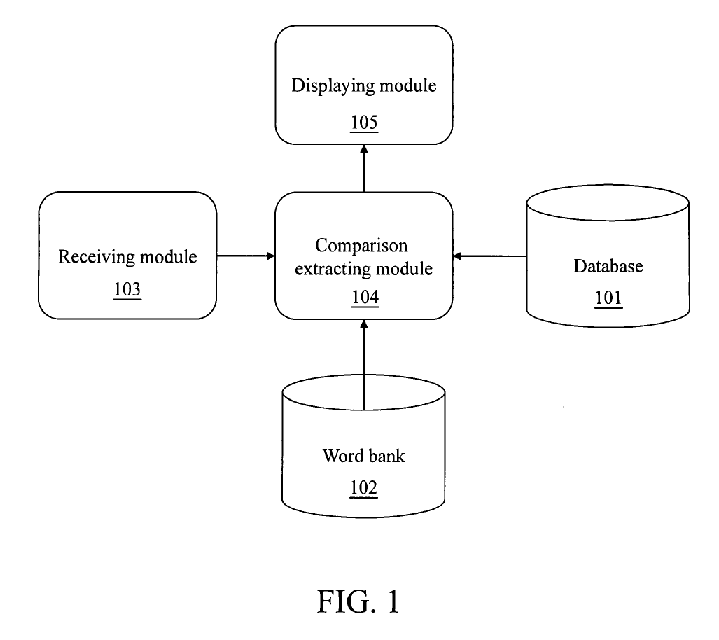

Please refer to FIG. 1 for the block diagram of the disclosed data searching system that generate derivative keywords according to input keywords. The system includes a database 101, a word bank 102, a receiving module 103, a comparison extracting module 104, and a displaying module 105.

The database 101 pre-stores at least one data item. The data items stored therein can be web pages for search engines, word entries of electronic dictionaries, files of a file system, or any other data that can be extracted using keywords. Since such data can vary among different fields of application, the invention does not impose any restriction on the kind of the data item in the database 101.

The word bank 102 pre-stores at least one keyword, wherein each of the keywords corresponds to at least one index. Each of the keywords stored in the word bank 102 is a word item. The index associated with each of the keywords is a classification according to the syntactical function and meaning of the keyword. For example, suppose a keyword is ‘connect’. The default index can be ‘noun’ or ‘verb’ as the syntactical function and ‘network’, ‘communication’, ‘topology’, ‘geometry’, and so on as the meanings. This particular example explains that the index of the keywords is used to show the correlation among the keywords. The actual classification method can be different.

The receiving module 103 receives an inquiry string entered by a user.

After the receiving module 103 receives the inquiry string entered by the user, the comparison extracting module 104 compares the inquiry string with the word items in the word bank 102 to obtain at least one first keyword. It should be noted that the first keyword is extracted from the inquiry string entered by the user. For example, suppose the user enters the inquiry string ‘sun light, air, water’. The comparison extracting module 104 compares it with the word bank 102 and generates ‘sun light’, ‘air’, and ‘water’ as the first keywords. Afterwards, the comparison extracting module 104 compares all of the indices associated with the first keywords. When the first keywords share at least one common index, the keywords in the word bank 102 with such shared index are extracted as second keywords. All of the first keywords and the second keywords are used to extract the corresponding data items in the database 101. For example, suppose the user enters the keywords ‘connect’ and ‘dial’, both share the common indices ‘communication’ and ‘network’. Suppose the keyword ‘radio’ has the index ‘communication’, and the keyword ‘optical fiber’ has the index ‘network’. In this case, ‘radio’ and ‘optical fiber’ are taken as the second keywords. The first keywords ‘connect’ and ‘dial’ and the second keywords ‘radio’ and ‘optical fiber’ are used to extract data items that contains the first keywords and the second keywords. When the first keywords do not share any common index, a word correlation algorithm is executed to obtain at least one third keyword. All of the first keywords and the third keywords are used to extract data items in the database 101.

It should be noted that the word correlation algorithm can be a longest common continuous string algorithm or a word combination algorithm. The longest common continuous string algorithm extracts the longest continuous words that are common among the keywords. For example, suppose the user enters the keywords ‘remark’ and ‘reply’. Then the longest common continuous part ‘re’ is extracted. After the longest common continuous part is extracted, the comparison extracting module 104 combines such extracted part with at least one wildcard character to extract at least one third keyword from the word bank 102. In the above-mentioned example, ‘re’ can be combined with the wildcard character ‘$’ to form ‘re$’. It is then used to extract ‘replace’, ‘response’, and so on from the word bank 102 as the third keywords. Although this example uses ‘$’ as the wildcard character, the wildcard character in effect can be any special symbol or character to achieve the same result.

The word combination algorithm follows combination rules of a language to combine several keywords into at least one combined word. The combined words are then compared with the word bank 102 to see whether they exist. If they do exist, then the combined words are used as the third keywords. For example, suppose the user enters ‘breakfast’ and ‘lunch’. According to the word combination algorithm, they can be combined to form ‘breakfastlunch’, ‘brunch’, ‘breaklunch’, and so on. Since the word bank 102 only has ‘brunch’ among the combined words, ‘brunch’ is taken as the third keyword. The invention is not limited to the above-mentioned example for combining words.

The disclosed data searching system that can generate derivative keywords according to original input keywords can thus achieve the goal of generating derivative keywords from original input keywords. It further uses the original input keywords and the derivative keywords to search for data. It can perform a more thorough search for data that have a certain correlation with the input keywords but do not directly contain the input keywords. This increases the integrity of data searches.

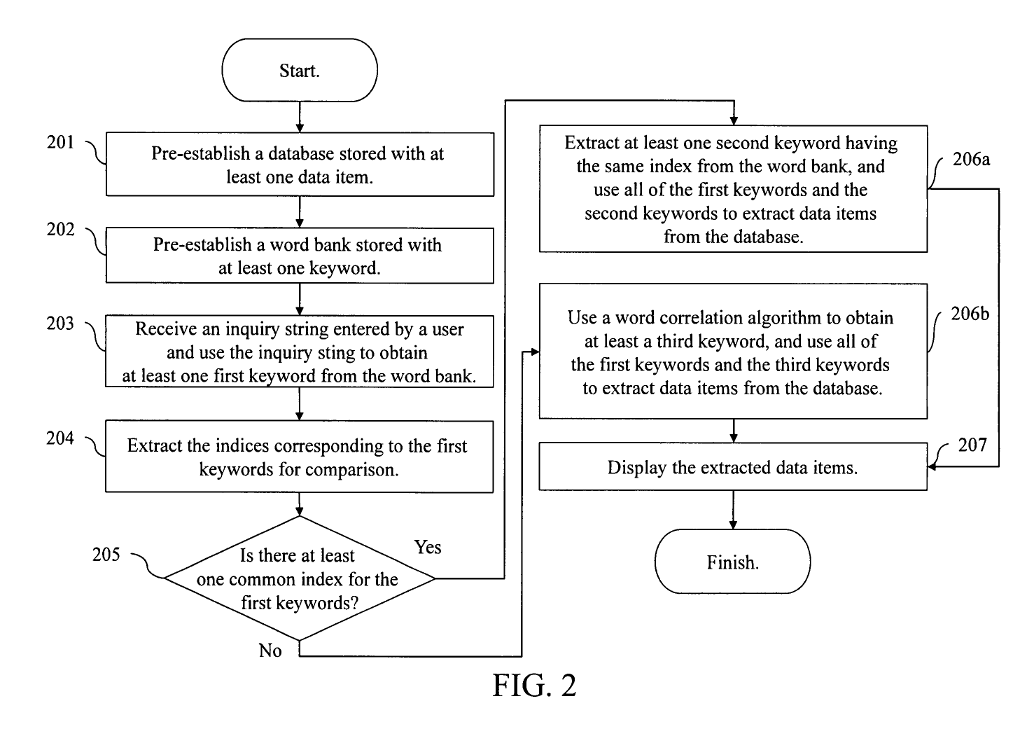

Please refer to FIG. 2 for a flowchart of the disclosed data searching method that can generate derivative keywords according to input keywords. An embodiment of a word data searching process on an English electronic dictionary using the invention is used to explain the details.

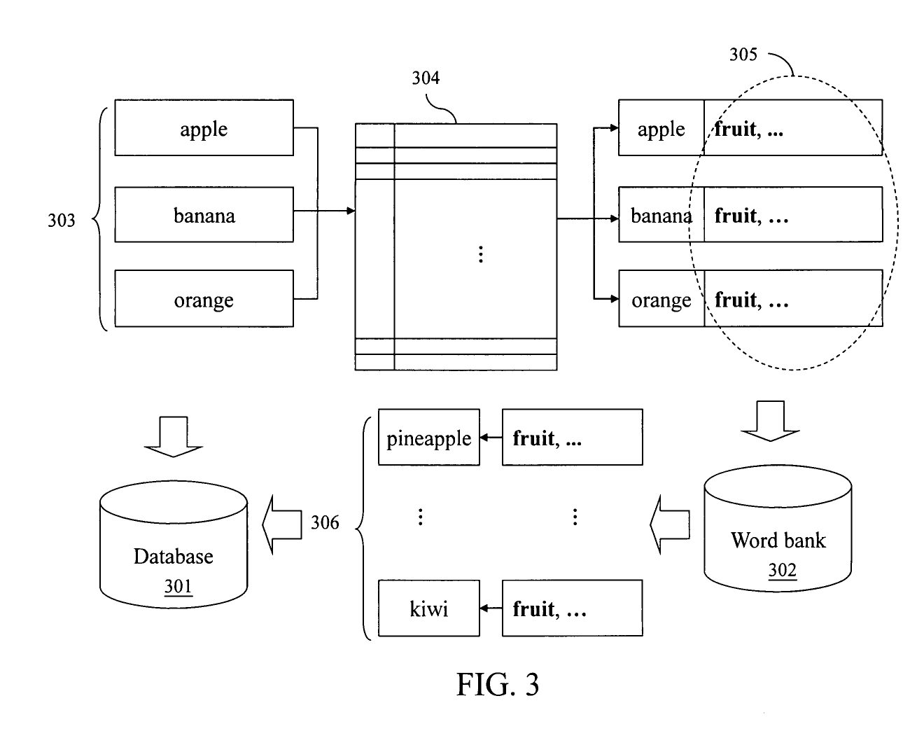

First, please refer to FIG. 3 simultaneously. Before the system's operation, a database 301 storing at least one data item is pre-established (step 201). In this embodiment, the database 301 pre-stores at least one word item. Each of the word items at least contains word explanations, example sentences, word usages, synonyms, antonyms, words of similar form, etc. Afterwards, a word bank 302 storing at least one keyword is pre-established (step 202). Different from the database 301, the keywords stored in the word bank 302 are the basis for word data searches. Each of the keywords corresponds to at least one index. The indices are built according to the syntactical function and meaning of the keywords. For example, suppose a keyword is ‘connect’. The default index can be ‘noun’ or ‘verb’ as the syntactical function and ‘network’, ‘communication’, ‘topology’, ‘geometry’, and so on as the meanings. Using these indices, the invention establishes the correlations among the keywords.

Afterwards, the method receives an inquiry string entered by a user and compares the inquiry string with the word bank to obtain at least one first keyword 303 (step 203). Suppose the first keywords are ‘apple’, ‘banana’, and ‘orange’. The system extracts indices 305 corresponding to the first keywords for comparison (step 204). During the comparison, the method first checks whether the first keywords have at least one common index (step 205). Suppose ‘apple’, ‘banana’, and ‘orange’ all have the same index ‘fruit’. The system then extracts at least one second keyword 306 with the same index ‘fruit’ from the word bank, wherein the second keywords, for example, can be keywords like ‘pineapple’, ‘grape’, ‘kiwi’, and so on. All of the first keywords 303 and all of the second keywords 306 are then used to extract data items from the database 301 (step 206a).

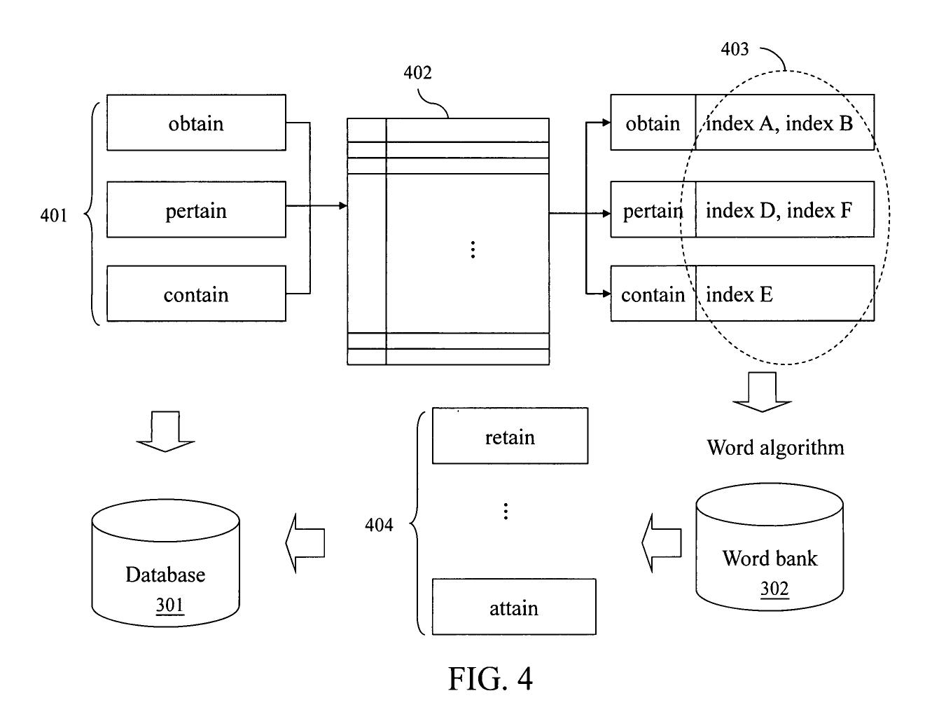

Please refer simultaneously to FIG. 4. Suppose the first keywords 401 entered by the user do not have a common index. For example, the first keywords are ‘obtain’, ‘pertain’, and ‘contain’. Assume that no common index 403 exists for them. In this case, the word correlation algorithm is used to obtain at least one third keyword 404. All of the first keywords 401 and all of the third keywords 404 are then used to extract data items from the database (step 206b).

It should be noted that the word correlation algorithm can be the longest common continuous string algorithm or the word combination algorithm. The longest common continuous string algorithm extracts the longest continuous words that are common among the keywords. Suppose the first keywords 401 are ‘obtain’, ‘pertain’, and ‘contain’. Then ‘tain’ is extracted to pair with a wildcard character such as “*” to form ‘*tain’. ‘*tain’ is then used to extract the third keywords 404 from the word bank, wherein the third keywords 404, for example, can be keywords like ‘retain’, ‘attain’, and so on that contain ‘tain’.

The word correlation algorithm can also be the word combination algorithm which follows combination rules of a language to combine several keywords into at least one combined word. The combined words are then compared with the word bank to see whether they exist. If they do exist, then the combined words are used as the third keywords. For example, suppose the user enters ‘breakfast’ and ‘lunch’. According to the word combination algorithm, they can be combined to form ‘breakfastlunch’, ‘brunch’, ‘breaklunch’, and so on. Since the word bank only has ‘brunch’ among the combined words, ‘brunch’ is taken as the third keyword.

After the system uses the first keywords and the second keywords or the first keywords and the third keywords to extract data, the results are displayed (step 207).

In summary, the invention differs from the prior art in that the invention compares the input inquiry string with the word bank to obtain at least one original input keyword. The invention further uses at least one original input keyword to generate derivative keywords. The original input keywords and the derivative keywords are all used for data searches. Through the above-mentioned technique, the invention achieves the effect of enhancing the data integrity in data searches.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A data searching system that generates derivative keywords according to input keywords, comprising:
a database pre-stored with at least one data item;
a word bank pre-stored with at least one keyword, wherein each of the keywords corresponds to at least one index;
a receiving module for receiving an inquiry string entered by a user;
a comparison extracting module for using the inquiry string to find at least one first keyword from the word bank and extracting the indices corresponding to each of the first keywords; wherein
when the first keywords have at least one common index, at least one second keyword having the index is extracted from the word bank and the first keywords and the second keywords are used to extract data items from the database; and
when the first keywords do not have any common index, a word correlation algorithm is used to obtain at least one third keyword and the first keywords and the third keywords are used to extract data items from the database; and
a displaying module for displaying the extracted data items.

2. The data searching system that generates derivative keywords according to input keywords of claim 1, wherein the indices are classifications of the keywords according to the syntactical function and meaning thereof.

3. The data searching system that generates derivative keywords according to input keywords of claim 1, wherein the word correlation algorithm is a longest common continuous string algorithm or a word combination algorithm.

4. The data searching system that generates derivative keywords according to input keywords of claim 3, wherein when the word correlation algorithm is the longest common continuous string algorithm, the comparison extracting module further combines the longest common continuous string, derived from the algorithm, and at least one wildcard character to extract at least one third keyword from the word bank.

5. The data searching system that generates derivative keywords according to input keywords of claim 3, wherein when the word correlation algorithm is the word combination algorithm, the comparison extracting module further uses at least one combined word, derived from the algorithm, as the third keyword(s).

6. A data searching method that generates derivative keywords according to input keywords, comprising the steps of:
pre-establishing a database stored with at least one data item;
pre-establishing a word bank stored with at least one keyword, wherein each of the keywords corresponds to at least one index;
receiving an inquiry string entered by a user and using the inquiry string to obtain at least one first keyword from the word bank;
extracting the indices associated with the first keywords from the word bank;
wherein
when the first keywords have at least one common index, at least one second keyword having the index is extracted from the word bank and the first keywords and the second keywords are used to extract data items from the database; and
when the first keywords do not have any common index, a word correlation algorithm is used to obtain at least one third keyword and the first keywords and the third keywords are used to extract data items from the database; and
displaying the extracted data items.

7. The data searching method that generates derivative keywords according to input keywords of claim 6, wherein the indices are classifications of the keywords according to the syntactical function and meaning thereof.

8. The data searching method that generates derivative keywords according to input keywords of claim 6, wherein the word correlation algorithm is a longest common continuous string algorithm or a word combination algorithm.

9. The data searching method that generates derivative keywords according to input keywords of claim 8, wherein when the word correlation algorithm is the longest common continuous string algorithm, the data searching method further combines the longest common continuous string, derived from the algorithm, and at least one wildcard character to extract at least one third keyword from the word bank.

10. The data searching method that generates derivative keywords according to input keywords of claim 8, wherein when the word correlation algorithm is the word combination algorithm, the data searching method further uses at least one combined word, derived from the algorithm, as the third keyword(s).
